(19) United States
(12) Patent Application Publication
(10) Pub. No.: US 2018/0101622 A1
(43) Pub. Date: Apr. 12, 2018

(54) PERFORM GRAPH TRAVERSAL WITH GRAPH QUERY LANGUAGE

(71) Applicant: MICROSOFT TECHNOLOGY LICENSING, LLC, Redmond, WA (US)

(72) Inventors: Torbjørn Helvik, OSLO (NO); Lorant Domokos, Seattle, WA (US)

(73) Assignee: MICROSOFT TECHNOLOGY LICENSING, LLC, Redmond, WA (US)

(21) Appl. No.: 15/286,649

(22) Filed: Oct. 6, 2016

(51) Int. Cl. G06F 17/30

(52) U.S. Cl. CPC G06F 17/30979; G06F 17/30991; G06F 17/3053; G06F 17/30958

(57) ABSTRACT

Variety of approaches to perform graph traversal utilizing a graph query language are described. A data service initiates operations to perform graph traversal upon receiving a graph query for processing a graph. The graph query includes a traversal operation. The graph query is executed for processing the graph with the traversal operation. Next, an outcome is identified from graph nodes of the graph as a result of the traversal operation. The outcome is provided for a presentation.

### BACKGROUND

Information exchange have changed processes associated work and personal environments. Automation and improvements in processes have expanded scope of capabilities offered for personal and business consumption. With the development of faster and smaller electronics, execution of mass processes at cloud systems have become feasible. Indeed, applications provided by data centers, data warehouses, data workstations have become common features in modern personal and work environments. Such systems execute a wide variety of applications ranging from enterprise resource management applications to data services. Many such applications manage data storage and access for users. Data storage and access consume significant resources and performance at a promise of improved user productivity.

Improved data storage and access techniques are becoming ever more important as data collection complexity increases across the computer industry. Variety of techniques are necessary to collect data, to structure the data, and (ultimately) to empower access and presentation of data for various work flows. There are currently significant gaps when accessing and presenting for a graph type data structure. Lack of relevant retrieval methods lead to poor utilization of a graph based data resources when attempting to traverse data stored in a graph.

### SUMMARY

This summary is provided to introduce a selection of concepts in a simplified form that are further described below in the Detailed Description. This summary is not intended to exclusively identify key features or essential features of the claimed subject matter, nor is it intended as an aid in determining the scope of the claimed subject matter.

Embodiments are directed to graph traversal utilizing a graph query language. A data service, according to embodiments, may initiate operations to provide the graph query language upon receiving a graph query for processing a graph. The graph query may include a traversal operation. The data service may execute the graph query for processing the graph with the traversal operation. An outcome may be identified from graph nodes of the graph as a result of the traversal operation. The outcome may be provided for a presentation.

These and other features and advantages will be apparent from a reading of the following detailed description and a review of the associated drawings. It is to be understood that both the foregoing general description and the following detailed description are explanatory and do not restrict aspects as claimed.

### BRIEF DESCRIPTION OF THE DRAWINGS

FIG. 1 is a conceptual diagram illustrating examples of performing graph traversal utilizing a graph query language, according to embodiments;

FIG. 2 is a display diagram illustrating an example scenario to provide a let operation and an augment operation for graph traversal utilizing a graph query language, according to embodiments;

FIG. 3 is a display diagram illustrating example scenarios to provide an “or match” operation and a “not match” operation for graph traversal utilizing a graph query language, according to embodiments;

FIG. 4 is a display diagram illustrating example scenarios to provide a collect operation and a nested operation for graph traversal utilizing a graph query language, according to embodiments;

FIG. 5 is a display diagram illustrating example scenarios to provide text search operations for graph traversal utilizing a graph query language, according to embodiments;

FIG. 6 is a simplified networked environment, where a system according to embodiments may be implemented;

FIG. 7 is a block diagram of an example computing device, which may be used to perform graph traversal utilizing a graph query language, according to embodiments; and

FIG. 8 is a logic flow diagram illustrating a process for performing graph traversal utilizing a graph query language, according to embodiments.

### DETAILED DESCRIPTION

As briefly described above, a data service may perform graph traversal utilizing a graph query language. In an example scenario, the data service may receive a graph query for processing a graph. An example of the graph may include structured data that includes nodes that are connected. A connection between nodes (also referred to as an edge) may describe a relationship between the nodes. The graph query may include a number of instructions that are formatted in a graph query language. The graph query may also include a traversal operation. The traversal operation may include number of instructions to search and filter nodes of the graph.

The data service may execute the graph query for processing the graph with the traversal operation. The traversal operation may search the graph with a pattern matching operation and filter the nodes of the graph based on the pattern matching operation. Next, an outcome may be identified from graph nodes of the graph as a result of the traversal operation. The outcome may include a selection from the graph nodes that match the instructions of the traversal operation (such as pattern matching, and/or filtering, among other instructions). The outcome may be provided for a presentation.

In the following detailed description, references are made to the accompanying drawings that form a part hereof, and in which are shown by way of illustrations, specific embodiments, or examples. These aspects may be combined, other aspects may be utilized, and structural changes may be made without departing from the spirit or scope of the present disclosure. The following detailed description is therefore not to be taken in a limiting sense, and the scope of the present invention is defined by the appended claims and their equivalents.

While some embodiments will be described in the general context of program modules that execute in conjunction with an application program that runs on an operating system on a personal computer, those skilled in the art will recognize that aspects may also be implemented in combination with other program modules.

Generally, program modules include routines, programs, components, data structures, and other types of structures that perform particular tasks or implement particular abstract data types. Moreover, those skilled in the art will appreciate that embodiments may be practiced with other computer system configurations, including hand-held devices, multiprocessor systems, microprocessor-based or programmable consumer electronics, minicomputers, mainframe computers, and comparable computing devices. Embodiments may also be practiced in distributed computing environments where tasks are performed by remote processing devices that are linked through a communications network. In a distributed computing environment, program modules may be located in both local and remote memory storage devices.

Some embodiments may be implemented as a computer-implemented process (method), a computing system, or as an article of manufacture, such as a computer program product or computer readable media. The computer program product may be a computer storage medium readable by a computer system and encoding a computer program that comprises instructions for causing a computer or computing system to perform example process(es). The computer-readable storage medium is a physical computer-readable memory device. The computer-readable storage medium can for example be implemented via one or more of a volatile computer memory, a non-volatile memory, a hard drive, a flash drive, a floppy disk, or a compact disk, and comparable hardware media.

Throughout this specification, the term “platform” may be a combination of software and hardware components to perform graph traversal utilizing a graph query language. Examples of platforms include, but are not limited to, a hosted service executed over a plurality of servers, an application executed on a single computing device, and comparable systems. The term “server” generally refers to a computing device executing one or more software programs typically in a networked environment. More detail on these technologies and example operations is provided below.

A computing device, as used herein, refers to a device comprising at least a memory and a processor that includes a desktop computer, a laptop computer, a tablet computer, a smart phone, a vehicle mount computer, or a wearable computer. A memory may be a removable or non-removable component of a computing device configured to store one or more instructions to be executed by one or more processors. A processor may be a component of a computing device coupled to a memory and configured to execute programs in conjunction with instructions stored by the memory. A file is any form of structured data that is associated with audio, video, or similar content. An operating system is a system configured to manage hardware and software components of a computing device that provides common services and applications. An integrated module is a component of an application or service that is integrated within the application or service such that the application or service is configured to execute the component. A computer-readable memory device is a physical computer-readable storage medium implemented via one or more of a volatile computer memory, a non-volatile memory, a hard drive, a flash drive, a floppy disk, or a compact disk, and comparable hardware media that includes instructions thereon to automatically save content to a location. A user experience—a visual display, a non-visual display (for impaired users as an example), and/or other user experience associated with an application or service through which a user interacts with the application or service. A user action refers to an interaction between a user and a user experience of an application or a user experience provided by a service that includes touch input, gesture input, voice command, eye tracking, gyroscopic input, pen input, mouse input, and/or keyboards input, among others. An application programming interface (API) may be a set of routines, protocols, and tools for an application or service that enable the application or service to interact or communicate with one or more other applications and services managed by separate entities.

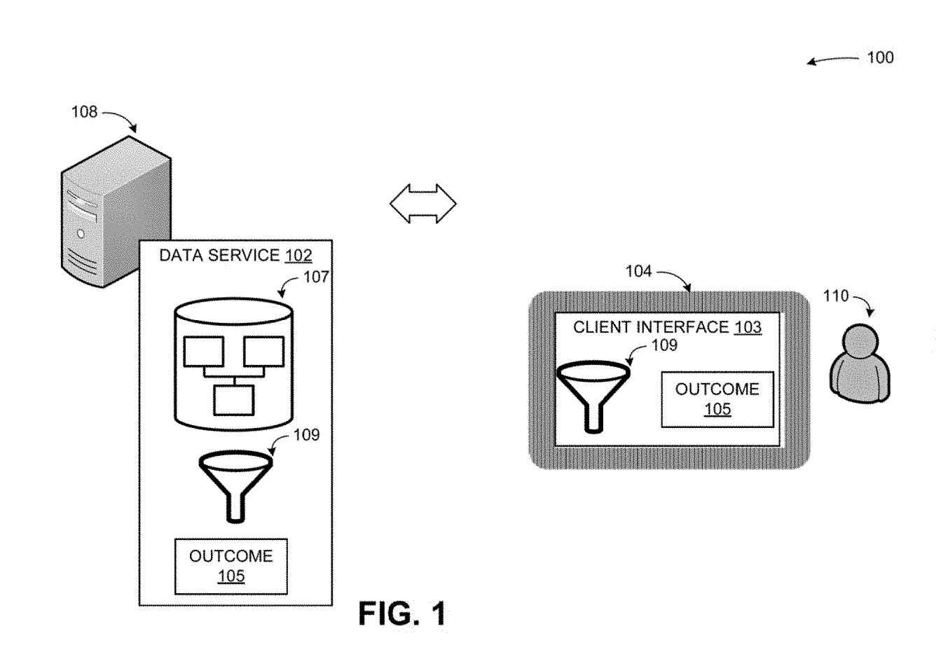

FIG. 1 is a conceptual diagram illustrating examples of performing graph traversal utilizing a graph query language, according to embodiments.

In a diagram 100, a physical server 108 may execute a data service 102. The physical server 108 may provide service(s) and/or application(s) to client devices. A service may include an application performing operations in relation to a client application and/or a subscriber, among others. The physical server 108 may include and/or is part of a workstation, a data warehouse, a data center, and/or a cloud based distributed computing source, among others.

The physical server 108 may execute the data service 102. The data service 102 may initiate operations to perform graph traversal upon receiving a graph query for processing a graph 107. An operator 110 may create the graph query using a client interface 103 presented by a client device 104. A graph may include a structured data (such as a tree) that includes nodes that are connected. Each connection (also referred to as an edge) may describe a relationship between the nodes. The graph query may include a number of operations to process graph nodes within the graph 107. The graph query may be formatted in a graph query language. The graph query may also include a traversal operation 109 (which may be created/edited by the operator 110).

Next, the data service 102 may execute the graph query for processing the graph 107. The traversal operation 109 may include instructions to search and filter the graph nodes within the graph 107. An outcome 105 may be identified from the graph nodes as a result of the traversal operation 109. The outcome may include a selection from the graph nodes that are identified from graph nodes upon executing the instructions of the traversal operation 109. The outcome 105 may be provided to the client interface 103 for a presentation to the operator 110.

The physical server 108 may communicate with the client device 104 through a network. The network may provide wired or wireless communications between network nodes such as the client device 104 and the physical server 108, among others. Previous example(s) to perform graph traversal utilizing a graph query language are not provided in a limiting sense. Alternatively, the data service 102 may execute the graph query for processing the graph 107 with the traversal operation 109 as a desktop application, a workstation application, and/or a server application, among others. The data service 102 may also generate and provide the client interface 103.

The operator 110 may interact with the client interface 103 with a keyboard based input, a mouse based input, a voice based input, a pen based input, and a gesture based input, among others. The gesture based input may include one or more touch based actions such as a touch action, a swipe action, and a combination of each, among others.

While the example system in FIG. 1 has been described with specific components including the physical server 108 and the data service 102. However, embodiments are not limited to these components or system configurations and can be implemented with other system configuration employing fewer or additional components.

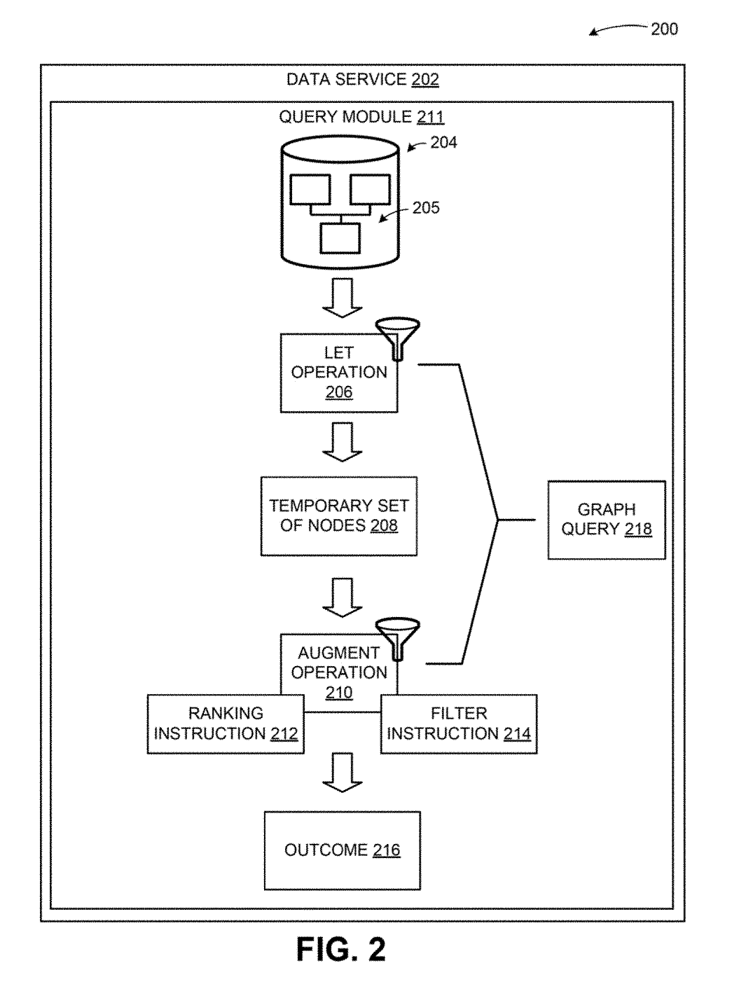

FIG. 2 is a display diagram illustrating an example scenario to provide a let operation and an augment operation for graph traversal utilizing a graph query language, according to embodiments.

In a diagram 200, a query module 211 of a data service 202 may receive a graph query 218 for processing a graph 204 with a traversal operation. The traversal operation may be one of number of operations in the graph query 218 that is formatted using a graph query language. In an example scenario, the traversal operation may include a let operation 206. The let operation 206 may include a set of instructions to generate a temporary set of nodes 208 from a selection of the graph nodes 205. An example of a let operation may include:

LET MyGroup =
MATCH (p:Person)
WHERE p.alias IN [“jdoe”, “msmith”]
SELECT p.*

where the temporary set of nodes 208 “MyGroup” is generated from a “Person” entity (which may include a table structure with multiple nodes) with nodes that have an alias property matching values “jdoe” and “msmith.” The select operation may retrieve all nodes matching the instructions of the let operation and insert the selection of the graph nodes 205 into the temporary set of nodes 208 “MyGroup.” The temporary set of nodes 208 may be provided to other traversal operations such as a pattern matching operation to select a subset of the temporary set of nodes 208 based on a term within the subset that matches the pattern within the pattern matching operation.

The temporary set of nodes 208 may be provided as the outcome 216 if the graph query 218 does not have any other operations besides the let operation 206. However, the graph query 218 may also include an augment operation 210. The augment operation 210 may include a ranking instruction 212, and/or a filtering instruction, among others to further process the temporary set of nodes 208. Upon execution, the ranking instruction 212 may order the temporary set of nodes 208. Similarly, the filter instruction 214 may select a subset of the temporary set of nodes upon execution. The outcome 216 may be produced upon processing the temporary set of nodes 208 with the augment operation 210. An example of the augment operation may include:

LET PeoplePivots =
MATCH (b:Person)-[w:WorkingWith]->(q:Person)
WHERE b.alias = “jdoe”
SELECT q.*, Score = w.Weight
ORDERBY Score DESCENDING
TAKE 10

where a temporary set of nodes 208 may be generated by selecting nodes that are related between the entities “Person” and “WorkingWith” where alias property for nodes of the “Person” entity matches the search term “jdoe.” The augment operation 210 may include a ranking instruction such as “ORDERBY Score Descending” which may order the temporary set of nodes 208 based on “Score” attribute associated with nodes of the “WorkingWith” entity. Furthermore, the augment operation 210 may also include a filtering instruction such as “TAKE 10” that may select a subset (10) from a top of the temporary set of nodes 208 that are ordered.

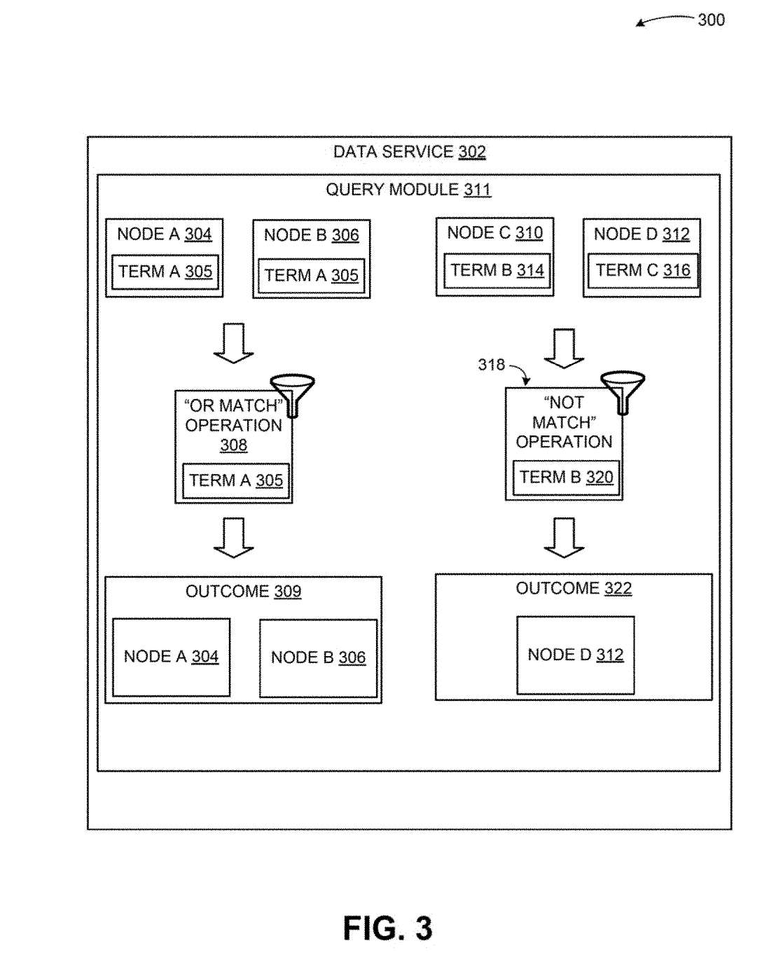

FIG. 3 is a display diagram illustrating example scenarios to provide an “or match” operation and a “not match” operation for graph traversal utilizing a graph query language, according to embodiments.

In a diagram 300, a query module 311 of a data service 302 may process graph nodes of a graph with an “or match” operation 308 detected within a graph query to produce an outcome 309. In an example scenario, the query module 311 may execute the “or match” match operation 308 to process the node A 304 and the node B 306. The “or match” operation 308 may execute an outer join operation to match a shared variable such as a term A 305 between the node A 304 and the node B 306. Since both the node A 304 and the node B 306 include the term A 305, the “or match” operation 308 may result in the outcome 309 that includes the node A 304 and the node B 306.

An example of the “or match” operation 308 may include:

MATCH (p:Person)-[m:Modified]->(d:Document)
WHERE p.alias = ‘jdoe’
OR MATCH (d)
WHERE d.author = ‘jdoe’

where nodes that are related between the entities “Person” and “Modified” may be selected for processing by the “or match” operation 308 where the nodes in the “Person” entity have an “alias” attribute matching the search term “jdoe.” The “or match” operation 308 may join selected nodes between the entities “Person” and “Modified” and execute an outer join with another selection of nodes from the entity “Document” where the other selection has an attribute “author” matching the term “jdoe.”

Alternatively, the graph query may include a “not match” operation 318. The “not match” operation 318 may search for graph node(s) that do not include a shared variable such as a term B 320 defined by the “not match” operation. In an example scenario, the “not match” operation 318 may be executed to process the node C 310 with a term B 314 and the node D 312 with a term C 316. The “not match” operation 318 may match the term B 320 to the node C 310. As such, Node D 312 may be selected for an insertion into an outcome 322 as a result of the “not match” operation 318 because the Node D 312 does not include the term B 314.

An example of the “not match” operation 318 may include:

MATCH (p:Person)-[m:Modified]->(d:Document)
WHERE p.alias = ‘jdoe’
NOT MATCH (q:Person)-[l:Liked]->(d)
WHERE q.alias = ‘msmith’

where a previous selection of nodes from the “match” operation may be further filtered by the “not match” operation 318 to exclude nodes from the person and like entities that are related to the document entity where the nodes from the person entity do not have an alias property of“msmith.”

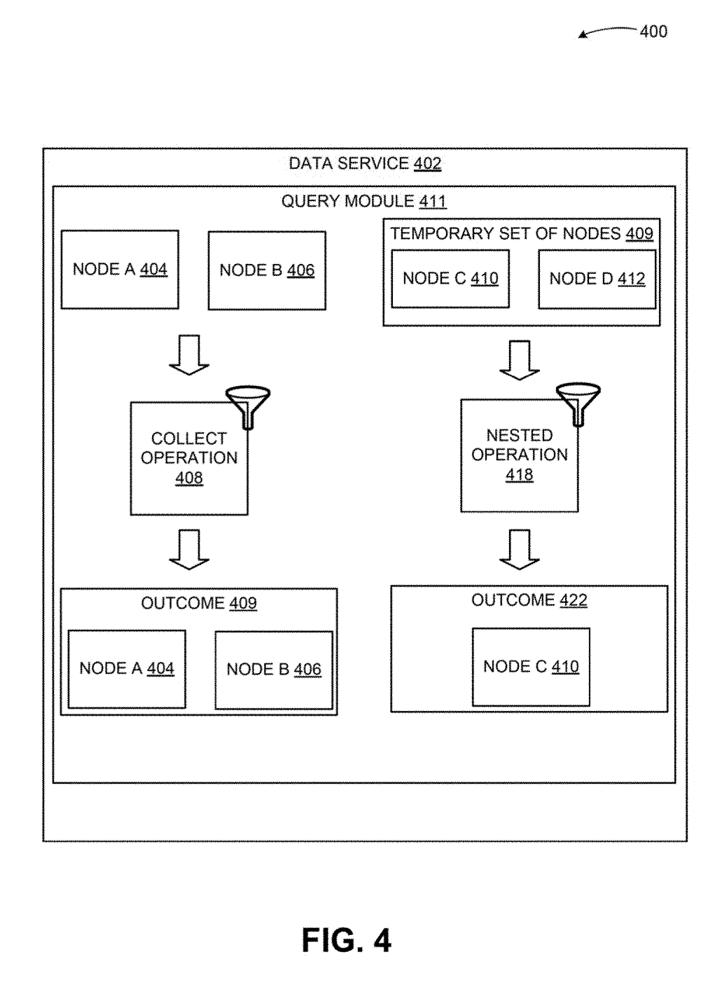

FIG. 4 is a display diagram illustrating example scenarios to provide a collect operation and a nested operation for graph traversal utilizing a graph query language, according to embodiments.

In a diagram 400, a query module 411 of a data service 402 may execute a collect operation 408 detected within a graph query to process a node A 404 and a node B 406. The collect operation 408 may combine the node A 404 and the node B 406 into an outcome 409. An example of a collect operation may include:

Info=Collect(Name=P.Name,Time=I.TimeStamp)

where nodes of a “name” entity (such as a table structure that includes graph nodes) may be combined with nodes of a “timestamp” entity to generate an “info” entity.

Furthermore, the query module 414 may execute a nested operation 418 detected within the graph query. The nested operation 418 may include another let operation and other traversal operation(s) (such as a match operation, and/or an augment operation, among others) to further filter a temporary set of nodes generated from a top level let operation detected within the graph query. In an example scenario, upon execution, the nested operation 418 may select a node C 410 from a temporary set of nodes 409 (that includes the node C 410 and a node D 412). The node C 410 may be provided as an outcome 422 upon executing the nested operation 418.

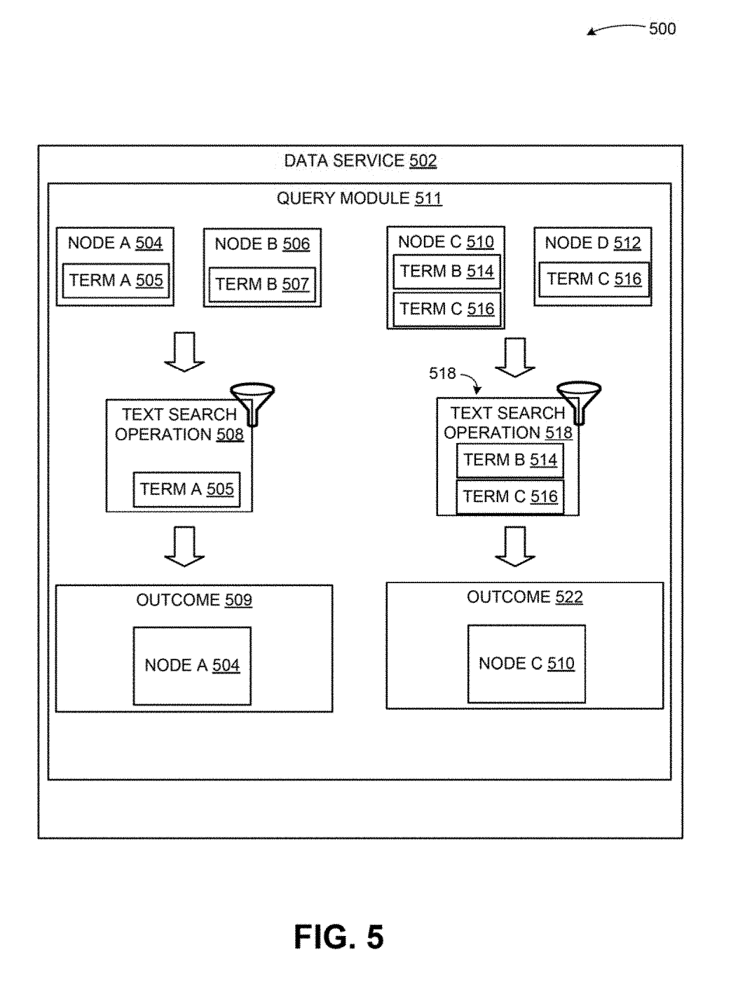

FIG. 5 is a display diagram illustrating example scenarios to provide text search operations for graph traversal utilizing a graph query language, according to embodiments.

In a diagram 500, a query module 511 of a data service 502 may detect a text search operation 508 to match a term A 505 to a selection of graph nodes that includes a node A 504 with a term A 505 and a node B 406 with a term 507. The text search operation 508 may match the term A 505 to the node 504. As such, the query module 511 may provide the node A 504 as an outcome 509 of the text search operation 508. An example of the text search operation 508 may include:

WHERE d:Document CONTAINS ‘graph nodes’

where nodes of an entity document that includes the terms “graph nodes” may be selected by the text search operation 508 (“CONTAINS”).

In another example scenario, a text search operation 518 may match two (or more terms) to a selection of graph nodes. For example, the text search operation 518 may match the term B 514 and the term C 516 to a node C 510 that includes the terms. The text search operation 518 may not match to a node D 512 that only includes the term C 516. As such, the query module 511 may provide the node C 410 as an outcome 522 of the text search operation 518. An example of the text search operation 518 may include:

WHERE d:Document CONTAINS (‘graph nodes’ and ‘architecture’)

where nodes of an entity document that include the terms “graph nodes” and “architecture” separated by a separator “and” may be selected by the text search operation 518. Alternatively, the text search operation 518 may also match to node C 510 and/or node D 512 with other separator(s) based on instructions in the text search operation 518 that describe the other separator(s) and a placement of the other separator(s) in between the term B 514 and the term C 516.

As discussed above, the data service may be employed to perform operations to automate graph traversal utilizing a graph query language. An increased user efficiency with the client interfaces of the data service 102 may occur as a result of searching and filtering graph nodes with a traversal operation. Temporary set of nodes (generated by a let operation) may be provided for additional processing by other traversal operation(s). Additionally, identifying an outcome as a result of the traversal operation, by the data service 102, may reduce processor load, increase processing speed, conserve memory, and reduce network bandwidth usage.

Embodiments, as described herein, address a need that arises from a lack of efficiency to perform graph traversal utilizing a graph query language. The actions/operations described herein are not a mere use of a computer, but address results that are a direct consequence of software used as a service offered to large numbers of users and applications.

The example scenarios and schemas in FIG. 1 through 5 are shown with specific components, data types, and configurations. Embodiments are not limited to systems according to these example configurations. Performing graph traversal utilizing a graph query language may be implemented in configurations employing fewer or additional components in applications and user interfaces. Furthermore, the example schema and components shown in FIG. 1 through 5 and their subcomponents may be implemented in a similar manner with other values using the principles described herein.

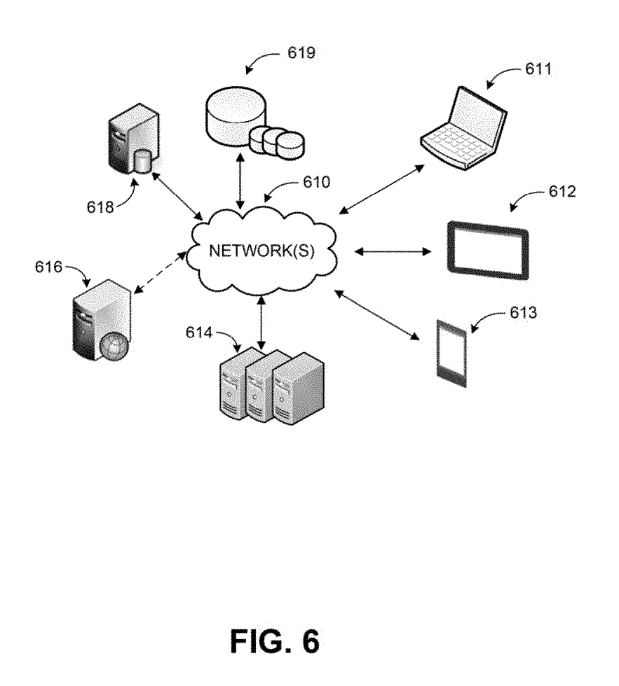

FIG. 6 is an example networked environment, where embodiments may be implemented. A data service configured to perform graph traversal utilizing a graph query language may be implemented via software executed over one or more servers 614 such as a hosted service. The platform may communicate with client applications on individual computing devices such as a smart phone 613, a mobile computer 612, or desktop computer 611 (‘client devices’) through network(s) 610.

Client applications executed on any of the client devices 611-613 may facilitate communications via application(s) executed by servers 614, or on individual server 616. A data service may initiate operations to perform graph traversal upon receiving a graph query for processing a graph. The graph query may include a traversal operation. The graph query may be executed for processing the graph with the traversal operation. An outcome may be identified from graph nodes of the graph as a result of the traversal operation. The outcome may be provided for a presentation. The data service may store data associated with the graph query in data store(s) 619 directly or through database server 618.

Network(s) 610 may comprise any topology of servers, clients, Internet service providers, and communication media. A system according to embodiments may have a static or dynamic topology. Network(s) 610 may include secure networks such as an enterprise network, an unsecure network such as a wireless open network, or the Internet. Network(s) 610 may also coordinate communication over other networks such as Public Switched Telephone Network (PSTN) or cellular networks. Furthermore, network(s) 610 may include short range wireless networks such as Bluetooth or similar ones. Network(s) 610 provide communication between the nodes described herein. By way of example, and not limitation, network(s) 610 may include wireless media such as acoustic, RF, infrared and other wireless media.

Many other configurations of computing devices, applications, data sources, and data distribution systems may be employed to perform graph traversal utilizing a graph query language. Furthermore, the networked environments discussed in FIG. 6 are for illustration purposes only. Embodiments are not limited to the example applications, modules, or processes.

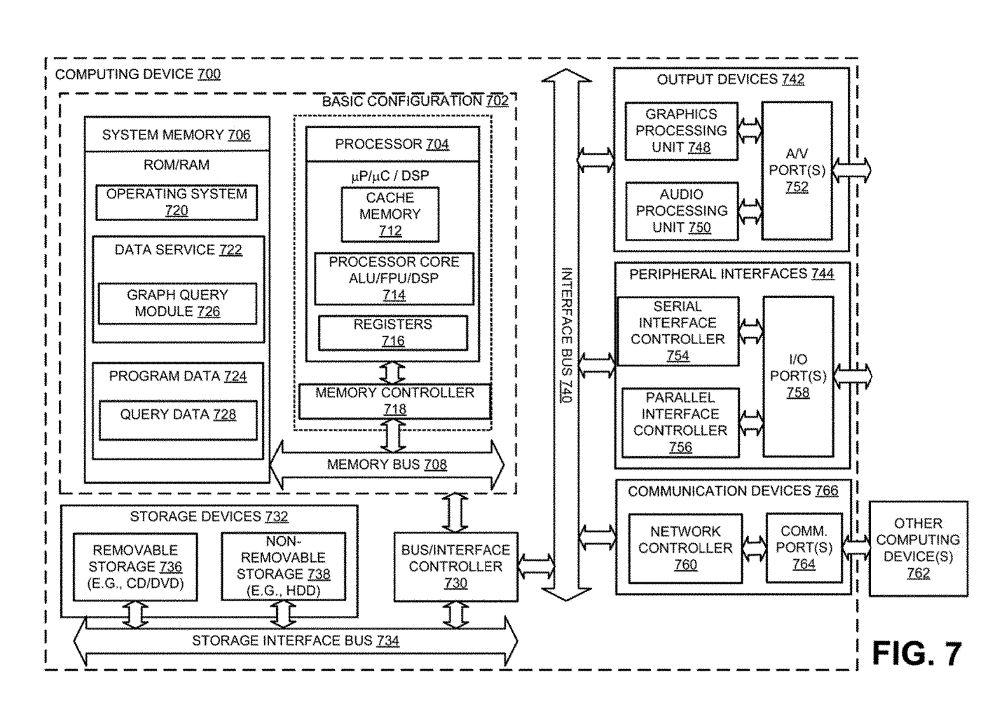

FIG. 7 is a block diagram of an example computing device, which may be used to perform graph traversal utilizing a graph query language, according to embodiments.

For example, computing device 700 may be used as a server, desktop computer, portable computer, smart phone, special purpose computer, or similar device. In an example basic configuration 702, the computing device 700 may include one or more processors 704 and a system memory 706. A memory bus 708 may be used for communication between the processor 704 and the system memory 706. The basic configuration 702 may be illustrated in FIG. 7 by those components within the inner dashed line.

Depending on the desired configuration, the processor 704 may be of any type, including but not limited to a microprocessor (μP), a microcontroller (μC), a digital signal processor (DSP), or any combination thereof. The processor 704 may include one more levels of caching, such as a level cache memory 712, one or more processor cores 714, and registers 716. The example processor cores 714 may (each) include an arithmetic logic unit (ALU), a floating point unit (FPU), a digital signal processing core (DSP Core), or any combination thereof. An example memory controller 718 may also be used with the processor 704, or in some implementations, the memory controller 718 may be an internal part of the processor 704.

Depending on the desired configuration, the system memory 706 may be of any type including but not limited to volatile memory (such as RAM), non-volatile memory (such as ROM, flash memory, etc.), or any combination thereof. The system memory 706 may include an operating system 720, a data service 722, and a program data 724. The data service 722 may include a component such as a query module 726. The query module 726 may execute the processes associated with the data service 722. The query module 726 may initiate operations to perform graph traversal upon receiving a graph query for processing a graph. The graph query may include a traversal operation. The graph query may be executed for processing the graph with the traversal operation. An outcome may be identified from graph nodes of the graph as a result of the traversal operation. The outcome may be provided for a presentation.

Input to and output out of the data service 722 may be transmitted through a communication module associated with the computing device 700. An example of the communication module may include a communication device 766 that may be communicatively coupled to the computing device 700. The communication module may provide wired and/or wireless communication. The program data 724 may also include, among other data, query data 728, or the like, as described herein. The query data 728 may include a traversal operation, among others.

The computing device 700 may have additional features or functionality, and additional interfaces to facilitate communications between the basic configuration 702 and any desired devices and interfaces. For example, a bus/interface controller 730 may be used to facilitate communications between the basic configuration 702 and one or more data storage devices 732 via a storage interface bus 734. The data storage devices 732 may be one or more removable storage devices 736, one or more non-removable storage devices 738, or a combination thereof. Examples of the removable storage and the non-removable storage devices may include magnetic disk devices, such as flexible disk drives and hard-disk drives (HDDs), optical disk drives such as compact disk (CD) drives or digital versatile disk (DVD) drives, solid state drives (SSDs), and tape drives, to name a few. Example computer storage media may include volatile and nonvolatile, removable, and non-removable media implemented in any method or technology for storage of information, such as computer-readable instructions, data structures, program modules, or other data.

The system memory 706, the removable storage devices 736 and the non-removable storage devices 738 are examples of computer storage media. Computer storage media includes, but is not limited to, RAM, ROM, EEPROM, flash memory or other memory technology, CD-ROM, digital versatile disks (DVDs), solid state drives, or other optical storage, magnetic cassettes, magnetic tape, magnetic disk storage or other magnetic storage devices, or any other medium which may be used to store the desired information and which may be accessed by the computing device 700. Any such computer storage media may be part of the computing device 700.

The computing device 700 may also include an interface bus 740 for facilitating communication from various interface devices (for example, one or more output devices 742, one or more peripheral interfaces 744, and one or more communication devices 666) to the basic configuration 702 via the bus/interface controller 730. Some of the example output devices 742 include a graphics processing unit 748 and an audio processing unit 750, which may be configured to communicate to various external devices such as a display or speakers via one or more A/V ports 752. One or more example peripheral interfaces 744 may include a serial interface controller 754 or a parallel interface controller 756, which may be configured to communicate with external devices such as input devices (for example, keyboard, mouse, pen, voice input device, touch input device, etc.) or other peripheral devices (for example, printer, scanner, etc.) via one or more I/O ports 758. An example of the communication device(s) 766 includes a network controller 760, which may be arranged to facilitate communications with one or more other computing devices 762 over a network communication link via one or more communication ports 764. The one or more other computing devices 762 may include servers, computing devices, and comparable devices.

The network communication link may be one example of a communication media. Communication media may typically be embodied by computer readable instructions, data structures, program modules, or other data in a modulated data signal, such as a carrier wave or other transport mechanism, and may include any information delivery media. A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, radio frequency (RF), microwave, infrared (IR) and other wireless media. The term computer readable media as used herein may include both storage media and communication media.

The computing device 700 may be implemented as a part of a general purpose or specialized server, mainframe, or similar computer, which includes any of the above functions. The computing device 700 may also be implemented as a personal computer including both laptop computer and non-laptop computer configurations. Additionally, the computing device 700 may include specialized hardware such as an application-specific integrated circuit (ASIC), a field programmable gate array (FPGA), a programmable logic device (PLD), and/or a free form logic on an integrated circuit (IC), among others.

Example embodiments may also include methods to perform graph traversal utilizing a graph query language. These methods can be implemented in any number of ways, including the structures described herein. One such way may be by machine operations, of devices of the type described in the present disclosure. Another optional way may be for one or more of the individual operations of the methods to be performed in conjunction with one or more human operators performing some of the operations while other operations may be performed by machines. These human operators need not be collocated with each other, but each can be only with a machine that performs a portion of the program. In other embodiments, the human interaction can be automated such as by pre-selected criteria that may be machine automated.

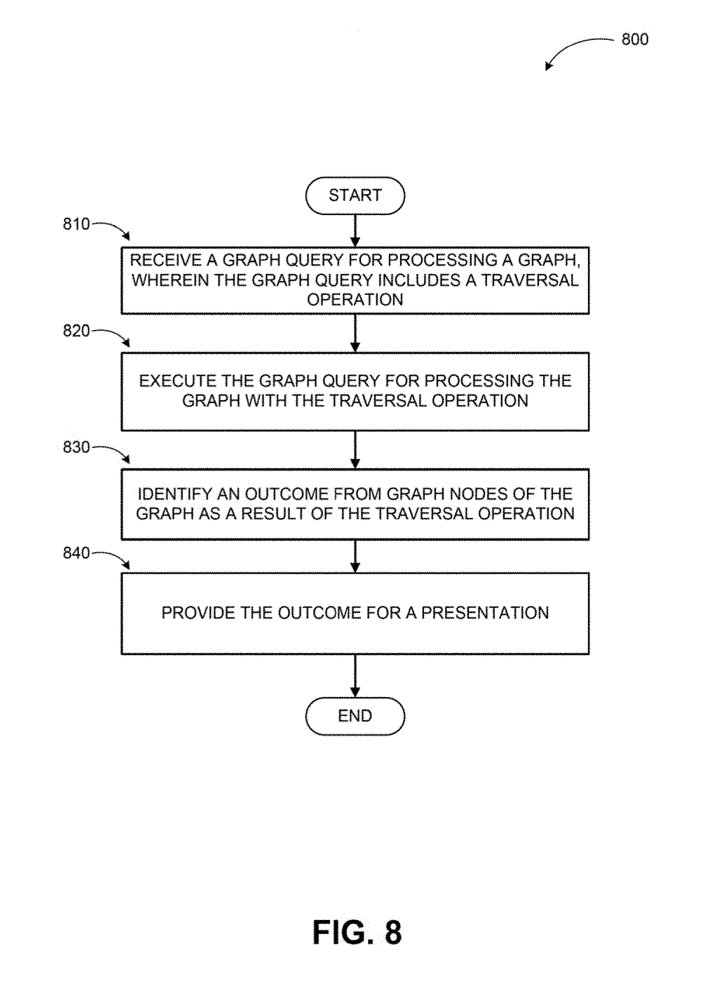

FIG. 8 is a logic flow diagram illustrating a process for performing graph traversal utilizing a graph query language, according to embodiments. Process 800 may be implemented on a computing device, such as the computing device 700 or another system.

Process 800 begins with operation 810, where the data service may receive a graph query for processing a graph. The graph query may include a traversal operation. At operation 820, the graph query may be executed for processing the graph with the traversal operation. The traversal operation may include a let operation, a match operation, an augment operation, a collect operation, a nested operation, and/or a text search operation, among others.

At operation 830, an outcome may be identified from graph nodes of the graph as a result of the traversal operation. The outcome may include a selection of the graph nodes that result from an execution of the traversal operation. At operation 840, the outcome may be provided for a presentation.

The operations included in process 800 is for illustration purposes. Performing graph traversal utilizing a graph query language may be implemented by similar processes with fewer or additional steps, as well as in different order of operations using the principles described herein. The operations described herein may be executed by one or more processors operated on one or more computing devices, one or more processor cores, specialized processing devices, and/or general purpose processors, among other examples.

In some examples, a physical server to perform graph traversal utilizing a graph query language is described. The server includes a communication module, a memory configured to store instructions associated with a data service, and a processor coupled to the memory and the communication module. The processor executes the data service in conjunction with the instructions stored in the memory. The data service includes a query module. The query module is configured to receive, through the communication module, a graph query for processing a graph, where the graph query includes a traversal operation, execute the graph query for processing the graph with the traversal operation, identify an outcome from graph nodes of the graph as a result of the traversal operation, and provide the outcome, through the communication module, for a presentation.

In other examples, the traversal operation includes a let operation. The query module is further configured to query a selection from the graph nodes based on an instruction in the let operation and generate a temporary set of nodes from the selection. The query module is further configured to provide the temporary set of nodes for additional processing by a pattern matching operation. The query module is further configured to detect an augment operation within the graph query and execute the augment operation for processing the temporary set of nodes, where the augment operation includes one or more of a ranking instruction and a filtering instruction. The query module is further configured to order the temporary set of nodes based on the ranking instruction. The query module is further configured to select a subset of the temporary set of nodes based on the filtering instruction.

The traversal operation includes an “or match” operation. The query module is further configured to generate a subset of the graph nodes by executing an outer join operation to match one or more shared variables between the graph nodes as defined by the “or match” operation and provide the subset of the graph nodes for additional processing to generate the outcome. The traversal operation includes a “not match” operation. The query module is further configured to identify an initial subset of the graph nodes that include one or more shared variables as defined by the “not match” operation, generate a remaining subset of the graph nodes, where the remaining subset of the graph nodes does not include the initial subset of the graph nodes, and provide the remaining subset of the graph nodes for additional processing to generate the outcome.

In some examples, a method executed on a computing device to perform graph traversal utilizing a graph query language is described. The method includes receiving a graph query for processing a graph, where the graph query includes a let operation and a traversal operation, generating a temporary set of nodes from a selection of graph nodes of the graph that are selected based on the let operation, processing the temporary set of nodes with the traversal operation to identify an outcome from the temporary set of nodes, and providing the outcome for a presentation.

In other examples, the traversal operation includes a collect operation. The method further includes combining two or more nodes from the temporary set of nodes into the outcome, where the two or more nodes are identified by the collect operation. The traversal operation includes a nested operation. The method further includes detecting other let operation and other traversal operation within the nested operation and executing the other let operation and the other traversal operation for additional processing of the temporary set of nodes. The method further includes detecting a text search operation as the traversal operation and executing the text search operation to filter the temporary set of nodes based on a text query defined by the text search operation.

In some examples, a computer-readable memory device with instructions stored thereon to perform graph traversal utilizing a graph query language is described. The instructions include actions that are similar to actions of the method. The instructions further include detecting a text search operation as the traversal operation, where the text search operation includes two or more text queries separated by a separate operator and executing the text search operation to filter the temporary set of nodes based on the two or more text queries and the separate operator to locate the outcome that matches the two or more text queries and the separate operator. The instructions further include detecting an “optional match” operation as the traversal operation, generating a subset of the temporary set of nodes by executing a left outer join operation to match one or more shared variables between the graph nodes as defined by the “optional match” operation, and providing the subset of the temporary set of nodes for additional processing to generate the outcome.

In some examples, a means for performing graph traversal utilizing a graph query language is described. The means for performing graph traversal utilizing a graph query language includes a means for receiving a graph query for processing a graph, where the graph query includes a traversal operation, a means for executing the graph query for processing the graph with the traversal operation, a means for identifying an outcome from graph nodes of the graph as a result of the traversal operation, and a means for providing the outcome for a presentation.

The above specification, examples and data provide a complete description of the manufacture and use of the composition of the embodiments. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and embodiments.

What is claimed is:

1. A physical server to perform graph traversal utilizing a graph query language, the physical server comprising:
a communication module;
a memory configured to store instructions associated with a data service;
a processor coupled to the memory and the communication module, the processor executing the data service in conjunction with the instructions stored in the memory, wherein the data service includes:
a query module configured to:
receive, through the communication module, a graph query for processing a graph, wherein the graph query includes a traversal operation;
execute the graph query for processing the graph with the traversal operation;
identify an outcome from graph nodes of the graph as a result of the traversal operation; and
provide the outcome, through the communication module, for a presentation.

2. The physical server of claim 1, wherein the traversal operation includes a let operation.

3. The physical server of claim 2, wherein the query module is further configured to:
query a selection from the graph nodes based on an instruction in the let operation; and
generate a temporary set of nodes from the selection.

4. The physical server of claim 3, wherein the query module is further configured to:
provide the temporary set of nodes for additional processing by a pattern matching operation.

5. The physical server of claim 3, wherein the query module is further configured to:
detect an augment operation within the graph query; and
execute the augment operation for processing the temporary set of nodes, wherein the augment operation includes one or more of a ranking instruction and a filtering instruction.

6. The physical server of claim 5, wherein the query module is further configured to:
order the temporary set of nodes based on the ranking instruction.

7. The physical server of claim 5, wherein the query module is further configured to:
select a subset of the temporary set of nodes based on the filtering instruction.

8. The physical server of claim 1, wherein the traversal operation includes an “or match” operation.

9. The physical server of claim 8, wherein the query module is further configured to:
generate a subset of the graph nodes by executing an outer join operation to match one or more shared variables between the graph nodes as defined by the “or match” operation; and
provide the subset of the graph nodes for additional processing to generate the outcome.

10. The physical server of claim 1, wherein the traversal operation includes a “not match” operation.

11. The physical server of claim 10, wherein the query module is further configured to:
identify an initial subset of the graph nodes that include one or more shared variables as defined by the “not match” operation;
generate a remaining subset of the graph nodes, wherein the remaining subset of the graph nodes does not include the initial subset of the graph nodes; and
provide the remaining subset of the graph nodes for additional processing to generate the outcome.

12. A method executed on a computing device to perform graph traversal utilizing a graph query language, the method comprising:
receiving a graph query for processing a graph, wherein the graph query includes a let operation and a traversal operation;
generating a temporary set of nodes from a selection of graph nodes of the graph that are selected based on the let operation;
processing the temporary set of nodes with the traversal operation to identify an outcome from the temporary set of nodes; and
providing the outcome for a presentation.

13. The method of claim 12, wherein the traversal operation includes a collect operation.

14. The method of claim 13, further comprising:
combining two or more nodes from the temporary set of nodes into the outcome, wherein the two or more nodes are identified by the collect operation.

15. The method of claim 12, wherein the traversal operation includes a nested operation.

16. The method of claim 15, further comprising:
detecting other let operation and other traversal operation within the nested operation; and
executing the other let operation and the other traversal operation for additional processing of the temporary set of nodes.

17. The method of claim 12, further comprising:
detecting a text search operation as the traversal operation; and
executing the text search operation to filter the temporary set of nodes based on a text query defined by the text search operation.

18. A computer-readable memory device with instructions stored thereon to perform graph traversal utilizing a graph query language, the instructions comprising:
receiving a graph query for processing a graph, wherein the graph query includes a let operation and a traversal operation;
generating a temporary set of nodes from a selection of graph nodes of the graph that are selected based on the let operation;
processing the temporary set of nodes with the traversal operation to identify an outcome from the temporary set of nodes; and
providing the outcome for a presentation.

19. The computer-readable memory device of claim 18, wherein the instructions further comprise:
detecting a text search operation as the traversal operation, wherein the text search operation includes two or more text queries separated by a separate operator; and
executing the text search operation to filter the temporary set of nodes based on the two or more text queries and the separate operator to locate the outcome that matches the two or more text queries and the separate operator.

20. The computer-readable memory device of claim 18, wherein the instructions further comprise:
detecting an “optional match” operation as the traversal operation;
generating a subset of the temporary set of nodes by executing a left outer join operation to match one or more shared variables between the graph nodes as defined by the “optional match” operation; and
providing the subset of the temporary set of nodes for additional processing to generate the outcome.
